(19) United States
(12) Patent Application Publication
(10) Pub. No.: US 2014/0176485 A1
(43) Pub. Date: Jun. 26, 2014

(54) TOUCH SCREEN, PORTABLE ELECTRONIC DEVICE, AND METHOD OF OPERATING A TOUCH SCREEN

(71) Applicants: Per Holmberg, Lund (SE); Tomas Kulle, Hjarup (SE); Bjorn Rosqvist, Lund (SE); Gunnar Klinghult, Lund (SE); Allan Johansson, Lund (SE); Lars Knutsson, Sjobo (SE); Georgeta Anton, Dalby (SE); Peter Aberg, Vinsolv (SE)

(72) Inventors: Per Holmberg, Lund (SE); Tomas Kulle, Hjarup (SE); Bjorn Rosqvist, Lund (SE); Gunnar Klinghult, Lund (SE); Allan Johansson, Lund (SE); Lars Knutsson, Sjobo (SE); Georgeta Anton, Dalby (SE); Peter Aberg, Vinsolv (SE)

(73) Assignee: SONY ERICSSON MOBILE COMMUNICATIONS AB, Lunt (SE)

(21) Appl. No.: 13/821,297

(22) PCT Filed: Dec. 20, 2012
(86) PCT No.: PCT/EP12/00265

§ 371 Date: Mar. 7, 2013

(51) Int. Cl. G06F 3/041; G06F 3/044

(52) U.S. Cl. CPC G06F 3/0414; G06F 3/044
USPC 345/174

(57) ABSTRACT

A touch screen comprises a display displaying through a front surface of the display and a sensor system. The sensor system is interposed between a back surface of the display and a bottom surface of a housing in which the touch screen is arranged. The sensor system comprises a first electrode assembly and a second electrode assembly and is configured to sense capacitance between the first electrode assembly and the second electrode assembly. The touch screen further comprises a processor being configured to determine based on the sensed capacitance a force resulting from the touch action.

### FIELD OF THE INVENTION

The application relates to a touch screen, a portable electronic device having a touch screen, and a method of operating a touch screen. The application relates in particular to touch screens which incorporate a sensor system being configured to sense capacitance and a processor being configured to determine, based on the sensed capacitance, a force.

### BACKGROUND OF THE INVENTION

Portable electronic devices provide functionalities which continue to be enhanced. With increasing processing capabilities and functionalities provided in the portable electronic device, it is increasingly challenging to provide input interfaces, for example in the form of touch screens, which allow the variety of functionalities and functions to be controlled in a direct and intuitive manner. Touch screens which sense touch action of a user enhance the way in which the user can interact with a portable electronic device. For example, touch screens are known which allow to determine a lateral position of a touch action or of a plurality of touch actions. This is referred to as multi-touch scenarios in which several fingers are used to simultaneously actuate different regions of the touch screen. For example it is often used to track the movement of a user's finger across a window on top of the touch screen. Based on the sensed lateral position of the touch action or the plurality of touch actions, a processor is configured to control at least one function of the portable electronic device.

One approach to further enhance the operation of touch screens is to derive information on a force of the touch action. For example, such information may be derived from the size of the area at which a user contacts a window of the touch screen. This is because the size of this area typically provides information on how the user places his or her finger on the window. Typically, if the user places the finger with a stronger force against the window, the area over which the touch action is detected will increase. While this approach does not require a separate sensor by deriving additional information from the size of the area in which the window is touched, it has shortcomings. It may be challenging to discriminate between users pushing against the window lightly with an index finger having large dimensions and users pushing strongly against the window with an index finger having small dimensions. Other approaches of determining the force of a touch action include providing separate sensor systems for determining the force. Also such systems have shortcomings. For example, the requirement of providing additional parts forming the additional sensor system for detecting the force of a touch action can result in increased space requirements which can make the portable electronic device larger in an undesired manner. Also, because additional parts have to be included in the portable electronic device, costs can increase and mean time between failure may decrease.

### SUMMARY

Accordingly, a need exists to provide advanced touch screens, advanced portable electronic devices, and advanced methods of operating touch screens which allow for additional information on the user's actuation on the touch panel to be derived.

This need is met by the independent claims. The dependent claims define embodiments.

According to an aspect, a touch screen responsive to a touch action and arranged in a housing having a bottom surface is provided. The touch screen comprises a display, a sensor system, and a processor. The display for displaying through a front surface of the display is mounted inside the housing and further comprises a back surface being offset by a gap from the bottom surface of the housing in a direction perpendicular to the bottom surface. The sensor system is interposed between the back surface and the bottom surface and comprises a first electrode assembly and a second electrode assembly. The first electrode assembly comprises at least one electrode and the second electrode assembly comprises at least one electrode. The sensor system is configured to sense capacitance between the first electrode assembly and the second electrode assembly. The processor is configured to determine, based on the sensed capacitance, a force resulting from the touch action.

The processor being configured to determine the force resulting from the touch action may do so by, for example, using a look-up table linking sensed capacitance with force. Also, it may be possible that the processor calculates the force using a predefined mathematical formula using the sensed capacitance as an input. Also a combination of such techniques may be possible. The determined force may comprise a magnitude and/or an orientation of the force. By accordingly configuring the first and second electrode assemblies, it may be possible to derive both magnitude and orientation of the force from the sensed capacitance.

For example, the housing may be a recess in a main body of a portable electronic device which employs the touch screen. If the touch screen is arranged in the housing forming the recess, it may be safe against undesired external influences, such as dust, fine particles, shock or liquids. In particular, edges of the touch screen, for example of a window arranged offset from the front surface, may be flush with edges of the housing such that foreign matter may be prevented from entering the inside area of the housing where the touch screen is arranged. The window may form a top surface of the touch screen. The front surface of the display may be arranged underneath the window, i.e., underneath the top surface, at a side of the display opposite to the side at which the back surface of the display is arranged. Provisioning of a gap between the back surface of the display and the bottom of the touch screen may be helpful in order to avoid unintended effects of degraded display quality when the user actuates the touch screen by a touch action. When the display is displaced due to the touch action, it may be desired to avoid contact between the back surface of the display and any other parts within the housing, in particular the bottom surface. Typical dimensions of the gap into which the sensor system is interposed, i.e., between the back surface of the display and the bottom surface of the housing, may be 0.3 mm.

Then, by interposing the sensor system between the back surface and the bottom surface, i.e. within the gap, already existing space within the housing may be favourably used to sense the capacity. Namely, when the touch action displaces the back surface of the display, the capacity between the first electrode assembly and the second electrode assembly may be altered because the top and bottom electrodes forming the electrode assemblies are brought closer together. The displacement may depend on the force of the touch action. Therefore, it may be possible to use this altered capacitance due to displacement in order to determine the force of the touch action.

The at least one electrode of the first electrode assembly may be integrally formed by the back surface of the display or may be attached to the back surface of the display. Likewise, the at least one electrode of the second electrode assembly may be integrally formed by the bottom surface of the housing or may be attached to the bottom surface of the housing.

By integrally forming the first and/or second electrode assemblies by the back surface and the bottom surface, respectively, the effect of a reduced number of parts necessary to built the sensor system may be achieved. This may reduce costs in procurement and assembly, and may increase the mean time between failure. Yet, if at least one of the electrodes of the first electrode assembly or at least one of the electrodes of the second electrode assembly is attached to the back surface of the display or the bottom surface of a housing, respectively, this may have the effect of increased flexibility of the arrangement of the electrodes. For example, a plurality of electrodes in different patterns may be provided if it is not necessary to rely on already existent other parts. Still, because the electrodes are interposed into the anyway existing gap, no additional space may be required. This may be desirable for applications targeting at portable electronic devices.

The processor may be further configured to determine the force based on differences of the sensed capacitance to a reference capacitance. Sensing differences to a reference capacitance, i.e., an offset capacitance, may have the effect of reduced error when determining the force. For example, manufacture tolerances of the dimensions between different touch screens of different portable devices or between different parts of the first and second electrode assembly or between different regions of individual electrodes may be compensated when determining the force by determining an offset of the sensed capacitance.

The sensor system may be further configured to sense capacitance spatially resolved and the processor may be configured to determine a lateral position of the touch action based on the spatially resolved sensed capacitance. By determining the lateral position of the touch action, further information may be available which can be used for controlling of functions of, e.g., a portable electronic device which comprises the touch screen. Different actions may be triggered depending on the lateral position and/or the force. In particular, it may be possible to provide interaction between a further sensor system being configured to determine a lateral position of the touch action, e.g., with larger lateral resolution. Different control schemes for functions of, e.g., a portable electronic device are conceivable which rely on the combined knowledge of position and force of a touch action or multi-touch action.

The display may be a liquid crystal display having a back reflector forming the back surface. A typical liquid crystal display (LCD) may consist of a polarizer, a color filter, a liquid crystal, a thin film transistor, a backlight, and a back reflector. The back reflector may have a surface which is optimized to reflect light emitted by the backlight towards the back surface into the direction of the front surface. However, it may also be possible that the back reflector forming the back surface has electrical properties which allow that the at least one electrode of the first electrode assembly is integrally formed by the back reflector. For example, the back reflector may have electrical characteristics, e.g., conductivity, of a metal. It may also be possible that the display is a organic light emitting diode (OLED) type display or any other type of display.

Moreover, at least one of the bottom surface of the housing, the back surface of the display, the first electrode assembly, or the second electrode assembly may be made out of a metal selected from the group comprising: conductive material, copper foil, electrolyte copper, metal. Such materials may have the effect of electronic properties which are suited for serving as electrodes in capacitance sensing by the sensor system. For example, the usage of such materials may have the effects of increased reference capacitance, offset capacitance, and increased signal-to-noise ratio of the sensed capacitance. As a result, the force may be more accurately determined.

The touch screen may comprise a further sensor system arranged offset to the front surface of the display in a direction perpendicular to the front surface, wherein the further sensor system is configured to sense a further signal. The touch screen may further comprise a further processor being configured to determine, based on the further signal, a lateral position of the touch action with a further lateral spatial resolution. By providing a further sensor system, e.g., in the form of a touch panel, which is arranged offset to the front surface of the display, the further sensor system may be arranged closer to a window where the touch action occurs, i.e., in the direction perpendicular to the front surface and orientated away from the back surface. In particular, if the further system is a capacitive sensor system, the further signal may have an increased signal-to-noise ratio. The lateral position of the touch action which is sensed by the further sensor system may therefore be accurately determined. Noise and background influences may be reduced. For example, it may be possible to optimize the sensor system for accurate force sensing and the further sensor system for accurate lateral position sensing.

In particular, a lateral spatial resolution of the sensor system may be smaller than the further lateral spatial resolution of the further sensor system. Information on the lateral position of the touch action may therefore be derived primarily from the further signal rather than from the capacitance sensed by the sensor system. The sensor system may be primarily employed to determine the force of the touch action while the further sensor system may be primarily employed to determine the position of the touch action.

Yet, the sensor system may be configured to individually sense capacitance between the at least one electrode of the first and second electrode assemblies and the processor may be further configured to determine the force in a spatially resolved manner based on the individually sensed capacitance. For example, if a plurality of electrodes is provided, by individually sensing the capacitance at each electrode, together with information on the arrangement of the electrodes, a spatial resolution may be obtained for the signal of the sensor system. Using electrodes having a large lateral spatial extent may have the effect of an increased signal-to-noise ratio, i.e., an increased accuracy, when determining the force—while only a comparably low spatial resolution may be obtained. Then, the determined force of different constituent touch actions of a multi-touch action may be linked with the respective high-resolution lateral positions obtained from a further sensor system.

For example, at least one of the first electrode assembly or the second electrode assembly may comprise at least four electrodes which may be arranged in a lateral pattern. By provisioning a plurality of electrodes and arranging the plurality of the electrodes in a predefined lateral pattern, spatial resolution in sensing the capacitance may be obtained. This may allow for further possibilities in the control of, e.g., a portable electronic device which is coupled to the touch screen.

The at least one electrodes of at least one of the first electrode assembly and the second electrode assembly may have an outer circumference substantially congruent with the outer edges of the back surface or the bottom surface, respectively. In such a scenario, the force of the touch action may be sensed even at positions close to the edges of the touch screen, i.e., across a wide area. This may have the effect of the user being able to employ the force of the touch action as an input means at the edges of the touch screen area.

To this respect, the first electrode assembly may cover an area substantially equal to the area covered by the back surface and/or the second electrode assembly may cover an area substantially equal to the area covered by the bottom surface. In such a case, it may be possible to sense the force of the touch action at any position across the display.

The display may comprise electronic circuitry being positioned offset from the back surface. The at least one electrode comprised in the first electrode assembly may be coupled to the electronic circuitry and the sensor system may address the at least one electrode via the electronic circuitry to sense capacitance. Typically, a display, e.g. a LCD or organic light emitting diode (OLED) type display, already may comprise electronic circuitry which is used for operation. If such electronic circuitry is positioned offset from the back surface, this may have the effect of allowing, for example, additional interfaces being provisioned in order to couple the electronic circuitry with the at least one electrode of the first electrode assembly being positioned close to the back surface of the display. By this, the sensor system may address the at least one electrode via the electronic circuitry to sense the capacity. In such a scenario, the amount of additional circuitry required in order to operate the sensor system may be reduced. This may reduce costs and potential for failure.

The first electrode assembly may comprise a plurality of top electrodes and the second electrode assembly may comprise a single bottom electrode, wherein the bottom electrode may be a ground electrode. For example, the bottom electrode may be integrally formed by the bottom surface of the housing being a mold steel frame. By provisioning a single ground electrode and a plurality of top electrodes, spatial resolution of the sensed force of the touch action may be achieved while reducing the number of parts necessary to build the sensor system. Capacity may be measured against one ground electrode by the different top electrodes. Also by employing the steel frame of the housing as a common ground electrode, already existing parts of the touch screen may be employed.

According to a further aspect, a portable electronic device is provided. The portable electronic device comprises a main body comprising a housing having a bottom surface, the housing forming a recess in the main body. The portable electronic device further comprises a touch screen responsive to a touch action and being arranged in the housing. The touch screen comprises a display and a sensor system and a processor. The display for displaying through a front surface of the display is mounted inside the housing and further comprises a back surface being offset by a gap from the bottom surface of the housing in a direction perpendicular to the bottom surface. The sensor system is interposed between the back surface and the bottom surface and the sensor system comprises a first electrode assembly comprising at least one electrode and a second electrode assembly comprising at least one electrode. The sensor system is configured to sense capacitance between the first electrode assembly and the second electrode assembly and the processor is configured to determine, based on the sensed capacitance, a force resulting from the touch action. The processor is further configured to control at least one function on the portable electronic device.

For example, the edges of the touch screen may be substantially flush with the edges of the recess formed by the housing in the main body. For example, the touch screen may comprise a window forming a top surface on which the touch action occurs. Then the edges of the window may be substantially flush with the edges of the recess. This may prevent dust, small particles, liquids etc. from entering the housing and thus protect the display.

The touch screen may be configured according to the touch screen of the further aspect of the present invention.

For such a portable electronic device effects may be obtained which are comparable to the effects obtained for the touch screen according to the further aspect of the present application.

According to a further aspect, a method of operating a touch screen comprising a display and being arranged in a housing is provided. The method comprises displaying through a front surface of the display, sensing a capacitance between a first electrode assembly and a second electrode assembly of a sensor system, the sensor system being interposed between a bottom surface of the housing and a back surface of the display opposing the front surface of the display. The method further comprises determining, based on the sensing of the capacitance, a force resulting from the touch action.

For such a method, effects may be obtained, which are comparable to the effects obtained for the touch screen of the further aspect of the present application and/or the portable electronic device of the further aspect of the present application.

It should be understood that the features mentioned above and features yet to be explained below can be used not only in a respective combinations as indicated, but also in other combinations or in isolation, without departing from the scope of the present invention. Features of the above-mentioned aspects and embodiments may be combined with each other in other embodiments.

### BRIEF DESCRIPTION OF THE DRAWINGS

The foregoing and additional features and effects of the application will become apparent from the following detailed description when read in conjunction with the accompanying drawings, in which like reference numerals refer to like elements.

FIG. 1 is a top view of a portable electronic device.

FIG. 2 is a cross-sectional view of the portable electronic device along the line labelled X-X in FIG. 1 according to an embodiment.

FIG. 3 is a cross-sectional view of the portable electronic device along the line labelled X-X in FIG. 1 according to a further embodiment.

FIG. 4 is a top-view of a first electrode assembly according to an embodiment.

FIG. 5 is a top-view of a first electrode assembly according to a further embodiment.

FIG. 6 is a top-view of a first electrode assembly according to a further embodiment.

FIG. 7 is a top-view of a first electrode assembly according to a further embodiment.

FIG. 8 is a schematic illustration of the portable electronic device of FIG. 1.

FIG. 9 is a flowchart of a method of operating a touch screen.

FIG. 10 shows a dependency of a magnitude of a force on a sensed capacitance.

### DETAILED DESCRIPTION OF EMBODIMENTS

In the following, embodiments of the invention will be described in detail with reference to the accompanying drawings. It is to be understood that the following description of the embodiments is not to be taken in a limiting sense. The scope of the invention is not intended to be limited by the embodiments described hereinafter with respect to the drawings, which are taken to be illustrative only. The features of various embodiments may be combined with each other unless specifically noted otherwise.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, units, components, or other physical or functional units shown in the drawings or described herein may also be implemented by an indirect connection or coupling. A coupling between components may also be established over a wireless connection. Functional blocks may be implemented in hardware, firmware, software, or a combination thereof. While portable electronic devices having a touch screen according to an embodiment may be wireless communication devices, personal digital assistants, or other portable communication devices, the touch screen is not limited to being used in such devices. Other fields, where the touch screen according to an aspect of the present application may be employed relate to stationary touch screens, touch screens for in-car electronic equipment, tablet computers, etc.

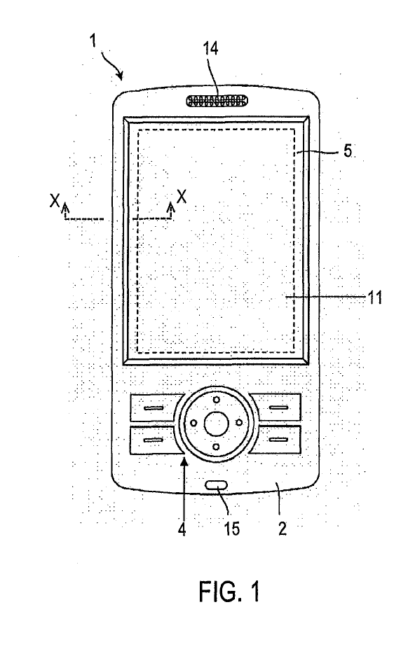

FIG. 1 is a top view showing the front of a portable electronic device 1. For example, the portable electronic device 1 may be a mobile phone or a personal digital assistant or a tablet computer. The portable electronic device 1 has a main body 2, e.g., made out of metal or rigid plastic. A microphone 15 and a loudspeaker 14 are provided for voice functions such as telephone calls. Embedded within the main body 2, a window 11 is arranged. The window 11 is part of a touch screen 5 and forms its outer top surface. The window is arranged accessible to a user of the portable electronic device 1 who may touch the window to cause a touch action. The touch screen 5 which is indicated schematically by a dashed line comprises a display (not shown in FIG. 1) displaying information to a user using the portable electronic device 1 through a front surface (not shown in FIG. 1) of the display arranged underneath the window 11 and through the window 11.

Also, the touch screen 5 is configured to sense particular parameters of the touch action corresponding to its position in the plane of the window 11, i.e., the lateral position, and its force. Here the force can correspond to the magnitude of the force, or the direction of the force, or both. These parameters can be used to control the functions of the portable electronic device 1. Multi-touch actions consisting of multiple touch actions can be used and the touch screen is configured to provide, to some degree, the parameters as set forth above for each of the constituting touch actions of the multi-touch action. Other input means include buttons 4 which are arranged in the main body 2 of the portable electronic device 1.

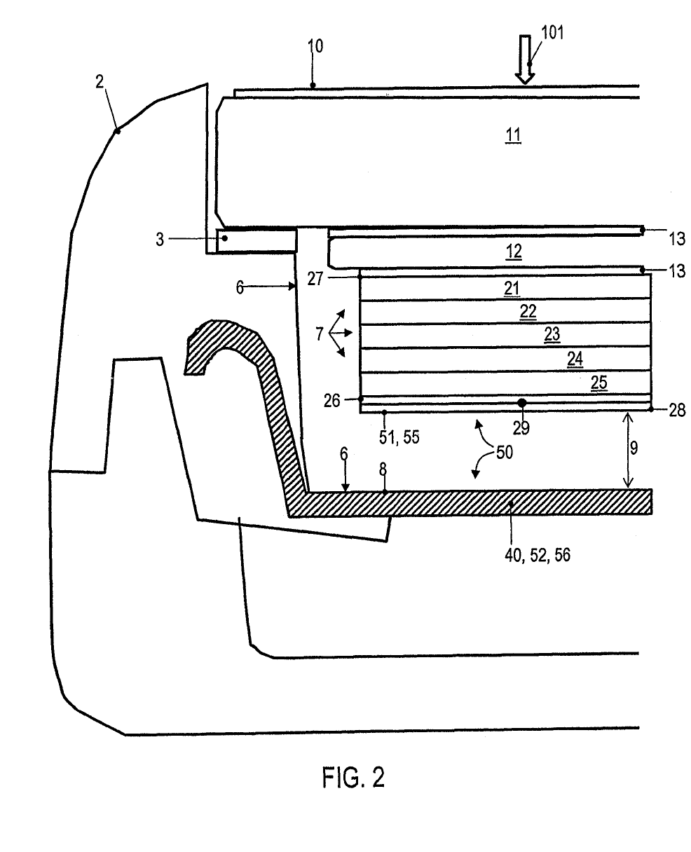

FIG. 2 is a cross-sectional view of the portable electronic device 1 of FIG. 1 along the line labelled X-X in FIG. 1 according to an embodiment of the invention. As can be seen from FIG. 2, on top of the window 11, there is a comparably thin protective film 10. Edges of the window 11 and the protective film 10 are substantially flush with the edges of the main body 2. A user may touch the protective film 10 or window 11. By doing so, this touch action exerts a force 101 on the protective film 10/window 11. This is illustrated in FIG. 2. Together they form a top surface. The window 11 is attached to the main body 2 using a support structure 3. Within the main body 2, a housing 6 is provided which forms a recess of the main body 2. The arrangement of the window 11 with respect to the main body 2 and the housing 6 hinders foreign matter, dust, small particles, liquids, etc. from entering the housing 6 and therefore reduces the risk of damage of touch screen 5. Inside the housing 6, several components of the touch screen 5 are arranged. These components will be explained hereinafter.

Underneath the window 11, separated by optical clear adhesive 13, there is provided a touch panel 12. The touch panel 12 may be configured for sensing a lateral position of the touch action. Therefore, the touch panel 12 may be in the form of a sensor system, the sensor system being configured to sense a signal. A processor (not shown in FIG. 2) is configured to determine, based on the sensed signal of the sensor system of touch panel 12, a lateral position of the touch action. Touch panels having a configuration as the touch panel 12 are known in the art and therefore there is no need to discuss further details in this context.

Again separated by optical clear adhesive 13, underneath the touch panel 12, there is arranged a display 7. Display 7 in FIG. 2 is in the form of a liquid crystal display (LCD). The LCD 7 has a front surface 27 facing the window 11. The touch panel 12 and the window 11 are arranged offset to the front surface 27 of the LCD 7 in a direction perpendicular to the front surface 27. From top to bottom, i.e. in the direction away from the window 11, the LCD 7 comprises the following units: adjacent to the front surface 27 is a polarizer 21, a color filter 22, a liquid crystal 23, a thin film transistor 24, a backlight 25, electronic circuitry in the form of a flexible printed circuit 26, and, lastly, a back surface in the form of a reflector film 28. The reflector film 28 is configured to reflect light emitted by the backlight 25 such that the display 7 displays through the front surface 27 and the window 11. Such an arrangement of the LCD 7 is known to the person skilled in the art such that details thereof need not to be discussed in this context.

As can be seen from FIG. 2, the entire LCD 7 is arranged within the housing 6 formed as a recess in the main body 2. In particular, between the back surface formed by the back reflector 28 and a bottom surface 8 of the housing 6 there is a gap 9. Therefore, the back surface 28 of the LCD 7 is offset by the gap 9 from the bottom surface 8 of the housing 6. The gap 9 is provisioned in order to avoid that the touch action can bring into contact the back surface 28 with the bottom surface 8. In the case of the embodiment of FIG. 2, typical dimensions of the gap may amount to approximately 0.3 mm. However, it should be understood that, for example due to manufacturing tolerances of these dimensions, there may be deviations from this value between different nominally identically manufactured portable electronic devices 1 or even between different positions within one and the same portable electronic device 1. In other words, the back surface 28 or the bottom surface 8 may be not entirely flat or may enclose a small but finite angle with each other.

The touch screen 5 of the embodiment shown in FIG. 2 comprises a sensor system 50 for capacity sensing. The sensor system 50 is interposed between the back surface 28 and the bottom surface 8. In particular, the sensor system 50 comprises a first electrode assembly 51 and a second electrode assembly 52 between which the capacity is sensed. The first electrode assembly 51 comprises at least one electrode 55 and the second electrode assembly comprises at least one electrode 56. In the embodiment of FIG. 2, the at least one electrode 55 of the first sensor assembly 51 is integrally formed by the back surface 28 of the LCD 7, i.e. by the back reflector film 28. In order for the back reflector film 28 to function as an electrode, certain requirements to the electrical properties need to be met. For example, the conductivity of the back reflector film 28 needs to be sufficiently large. The at least one electrode 56 of the second sensor assembly 52 is integrally formed by a frame 40 being a mold steel frame and forming bottom surface 8. Typically, mold steel has electrical properties which allow to employ the frame 40 for forming the electrodes 56.

The sensor system 50 is configured to sense a capacity between the at least one electrode 55, i.e. the top electrodes 55, of the first sensor assembly 51 and the at least one electrode 56, i.e. the bottom electrodes 56, of the second electrode assembly 52. For example, when a user touches the protective film 10 of the portable electronic device 1, i.e. the window 11, the touch screen 5 will be forcedly displaced towards the bottom of FIG. 2. The distance of displacement depends on the magnitude of the force and the structural properties of, amongst others, the support structure 3 and the touch-screen 5. Due to the displacement, the dimensions, i.e., distance of gap 9 will decrease. The area over which the distance of gap 9 decreases can depend on the lateral position of the touch action. When the distance of gap 9 decreases, also the capacitance between the top electrodes 55 and the bottom electrodes 56 will change. For example, it can be possible to tailor the displacement characteristics and, via this, the characteristics of the sensor system 50, by adjusting the respective structural properties such as rigidity of the various members of touch screen 5, e.g., window 11 or the support structure 3. It is possible that the window 11 bends in portions remote from the display 7, i.e. above the support structure 3. For example, it can also be possible that a touch action changes the distance of the gap 9 only locally where the touch action occurs or changes the distance of the gap 9 across a larger area. It can be possible to maintain a substantially flat back surface 28 or deform the back surface 28 when a touch action occurs. It is also possible that the distance of gap 9 will differ substantially between the different electrodes 55, 56 of the electrode assemblies 51,52. Such parameters can enter the operational characteristics of the sensor system 50.

The sensor system 50 can be configured to sense, in particular, a change in the capacitance, i.e., an offset capacitance between the state with and without the touch action. Based on this, a processor (not shown in FIG. 2) is configured to calculate the force 101 of the touch action. For example, the processor can be configured to determine the magnitude of the force 101 or, given a particular suited sensor system 50 as set forth above, the orientation of the force 101 of the touch action. Furthermore, the processor is configured to control at least one function of the portable electronic device 1 based on the determined force 101. In other words, the user may selectively trigger certain functions by varying the force 101 of the touch action.

The sensor system 50 is configured to access or read out the top electrodes 55 via the flexible printed circuit 26 coupled to the top electrodes 55 via interconnections 29. The flexible printed circuit 26 being part of the LCD 7 is used also in order to operate the backlight 25. Via provisioning of the interface 29, the electronic circuitry 26 can be further employed in order to allow the sensor system to sense the capacitance. For example, if the bottom electrode 56 is a ground electrode, it can be unnecessary to read out any electrical values from the bottom electrode 56. Rather, it can be sufficient to have electric connection to the top electrode 55 in order to be able to determine the capacitance. It is also possible to measure the duration of time needed for one or more of the electrodes 55, 56 to discharge. This discharge time can be a measure of the capacitance.

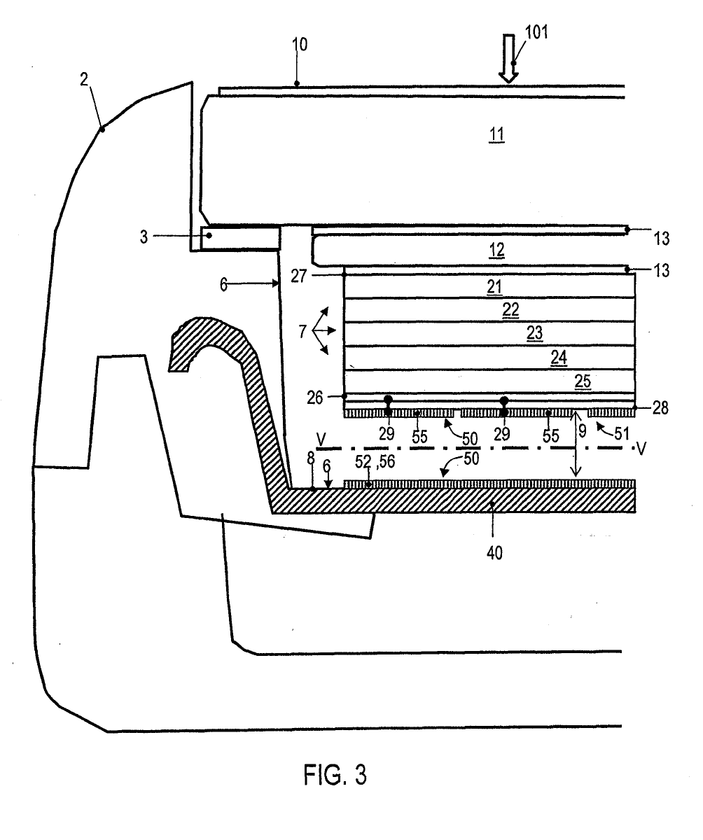

Turning to FIG. 3, a further embodiment of the touch screen 5 according to the present invention is depicted. Also FIG. 3 is a cross-sectional view along the line marked X-X in FIG. 1. However, in the embodiment of FIG. 3, a plurality of top electrodes 55 is provided attached to the back surface 28, i.e. the back reflector film of LCD 7. Rather than integrally forming the top electrodes 55 by the back surface 28, the top electrodes 55 are attached to the back surface 28 of the display 7. The top electrodes 55 of the embodiment in FIG. 3 have smaller dimensions along the cross-sectional view if compared to the embodiment of FIG. 2. This allows for providing a certain lateral resolution when sensing the capacitance and determining the force being approximately equal to the extents or the spacing of the electrodes 55. Then, for example, the force 101 of each touch of a multi-touch action can be determined individually. For example, the top electrodes 55 may be made of copper foil attached with an adhesive to the back surface 28 or may be electrolyte copper or any other conductive material. A plurality of interfaces 29 is provisioned in order to individually couple the top electrodes 55 to the electronic circuitry 26. This allows to individually read out each of the plurality of top electrodes 55 and therefore sense capacitance spatially resolved.

As can be further seen from FIG. 3, the bottom electrode 56 is also attached to the frame 40, for example by an adhesive or inmold. This can be desirable if the frame 40 is not made of a conductive material, but, e.g., from a plastic material. Furthermore, in the embodiment of FIG. 3, the bottom electrode 56 is not laterally structured as are the top electrodes 55.

It should be understood that the embodiments depicted in FIGS. 2 and 3 can be combined to a large extent. For example, it is possible that the top electrodes 55 form a single ground electrode while the bottom electrodes 56 are laterally structured. It is also possible, that, both, top and bottom electrodes 55, 56 are attached to the back surface 28 and the bottom surface 8, respectively, and are both laterally structured or a both not structured. It can also be possible to provide electronic circuitry to read out the second electrode assembly 52 rather than the first electrode assembly 51 or even provide electronic circuitry to read out both electrode assemblies 51, 52.

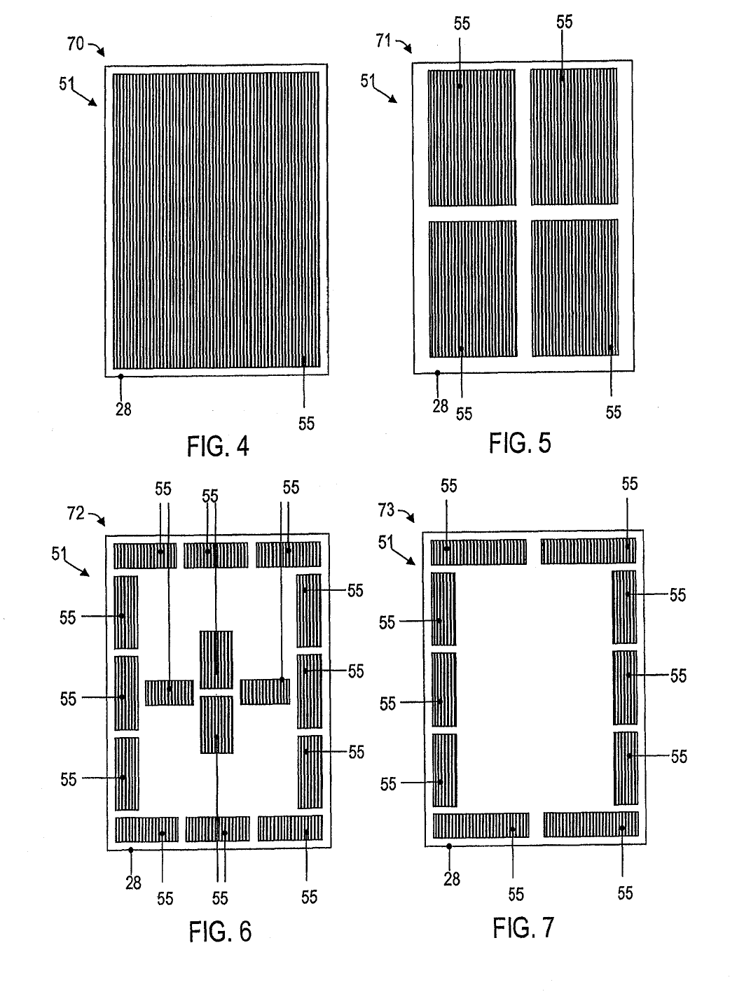

The plurality of top electrodes 55 of the embodiment of FIG. 3 can be arranged in a lateral pattern. Different lateral patterns 70-73 are schematically depicted in FIGS. 4-7. FIGS. 4-7 resemble views of the top electrodes 55 taken along the line labelled V-V in FIG. 3. In FIG. 4, a first lateral pattern 70 of the top electrode assembly 50, i.e. the top electrode 55 is shown. In the case of FIG. 4, the lateral pattern 70 refers to a single top electrode 55 extending substantially across the entire area of the back surface 28. When provisioning a single top electrode 55 extending across approximately the entire area of the back surface 28, a maximum capacitance may be achieved between the top and bottom electrodes 55, 56. In the embodiment of FIG. 4, spatially resolving the determined force 101 is not possible unless the bottom electrode 56 (not shown) is structured and individually read out by the sensor system 50. This is different in the embodiments depicted in FIGS. 5, 6, and 7. In these Figures, different patterns 71, 72, 73 of the top electrodes 55 of the top electrode assembly 51 are depicted. In FIG. 5, four top electrodes 55 are provisioned. In FIG. 6, sixteen top electrodes 55 are provisioned. In FIG. 7, ten top electrodes 55 are provisioned. For example, even though the pattern 72 shown in FIG. 6 does not cover the entire area of the back surface 28, it nonetheless has an outer circumference substantially congruent with the outer edges of the back surface 28. Depending on the particular functions of the portable electronic device 1 to be controlled via force sensing as set forth above with respect to the FIGS. 1-3, a particular one of the patterns 70-73 may be chosen. A pattern as those patterns 70-74 shown in FIGS. 4-7 may be obtained, e.g., by cutting copper foil to the respective dimensions and attaching each piece of copper foil to the back surface 28 to form a single one of the top electrodes 55. However, it should be understood, that the patterns 70-73 as depicted in FIGS. 4-7 are not be construed as being limited. Different patterns employing a different number and/or arrangement of the electrodes 55, 56 are possible. It should also be understood that, while in FIGS. 4-7 patterns are shown with respect to the top electrode assembly 51, such patterns or different patterns can also be applied to the electrodes 56 of the bottom electrode assembly 52. It is also possible that top and bottom electrode assemblies 51, 52 comprise the same pattern, different patterns, etc.

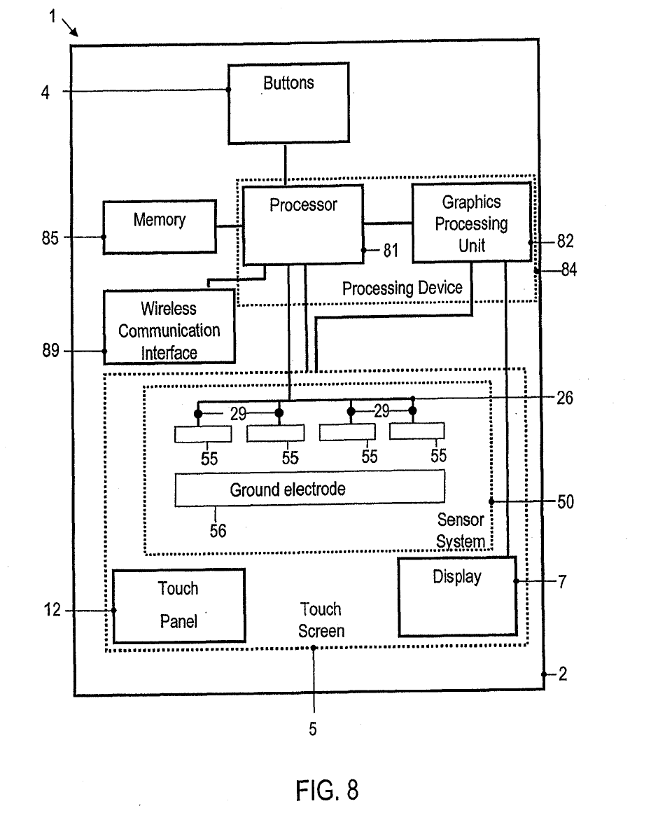

In FIG. 8, a schematic illustration of the portable electronic device 1 of FIG. 1 is depicted. The portable electronic device 1 comprises a processing device 84. The processing device 84 comprises one or a plurality of processors 81. The processing device 84 further comprises one or a plurality of graphics processing units 82. The graphics processing unit 82 can display a current graphics frame on the display 7. The units 81, 82 can be implemented as separated units or can be implemented as one unit, for example on a single board, or as multi-core processors, or a software code only, etc. Coupled to the processor 81 is a memory 85. Also coupled to the processor 81 is a wireless communication interface 89, which can, for example, be used to establish a telephone call connection to a mobile communication network via industry standards. Furthermore, the processor 81 is coupled to the touch screen 5.

For example the touch screen 5 comprises the touch panel 12 and the sensor system 50. The touch panel 12 can be used in order to detect a lateral position of a touch action. Complementary, the sensor system 50 can be used in order to determine the force 101 of the touch action. As discussed with respect to FIGS. 1-3, schematically indicated in FIG. 8 is a plurality of five top electrodes 55 and a single ground electrode 56. The top electrodes 55 are coupled via interfaces 29 to electronic circuitry 26 which, in turn, is coupled to the processor 81. The processor 81 is configured to determine the force based on the sensed capacity between the top electrodes 55 and the ground electrode 56. The capacity between each of the top electrodes 55 and the ground electrode 56 can be sensed individually such that the force 101 of the touch action or the force 101 of a multi-touch action can be determined with spatial resolution. The processing device 84 can control a function of the portable electronic device 1 based on commands received from the user of the portable electronic device 1. Such commands can be input via the buttons 4 being pushed, a laterally resolved position of the touch action as sensed by the touch panel 12, or the force 101 of the touch action as sensed via the capacity between the electrodes 55, 56 by the sensor system 50.

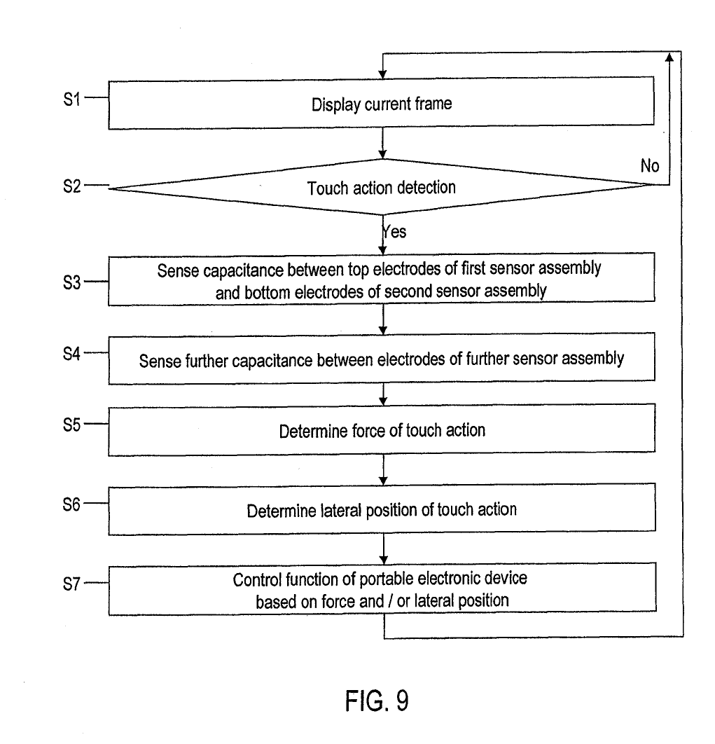

Next, turning to FIG. 9, a flow diagram of a method of operating the touch screen 5 is discussed. First, in step S1 a current graphics frame is displayed using the display 7. For example, the frame can be calculated by the graphics processing unit 82. The frame can comprise graphical representations of buttons etc. which a user of the portable electronic device 1 can touch via a touch action.

Next, in step S2, it is checked whether such a touch action is detected. For example, the touch action can be a multi-touch action consisting of a plurality of constituting touch actions. For sake of simplicity, FIG. 9 makes reference to a single touch action in a non limiting way. If in step S2 no touch action is detected, step S1 is repeated with an updated current frame. However, if a touch action is detected, for example via a change in the sensed signals, step S3 is performed. In step S3, a capacitance between the top electrodes 55 of the first electrode assembly 51 and the bottom electrodes 56 of the second sensor assembly 52 is sensed by the sensor system 50. Sensing a capacity means providing a measured value of the capacitance.

Next, in step S4, a further capacitance is sensed between electrodes of a further sensor system, for example the touch panel 12.

Next, in step S5, the force 101 of the touch action as detected in step S2 is determined, for example by the processor 81. The force 101 of the touch action is determined in step S5 based on the sensed capacitance in step S3. This can be done by means of a look-up table, a predefined relationship, executing mathematical operations, or the like. In particular an offset capacitance can be used which is defined against a baseline capacitance for the case where no touch action is present. It should be understood that if the touch action relates to a multi-touch action, both the capacitance sensed in step S3 as well as the force determined in step S5 can be spatially resolved.

Likewise, in step S6 the lateral position of the touch action is determined, for example by the processor 81. The lateral position is determined from the sensed further capacitance of step S4. Again, if a touch action is a multi-touch action, the lateral position of each touch action of the plurality of touch actions performing the multi-touch action can be determined.

Next, in step S7, a function of the portable electronic device is controlled based on the force 101 determined in step S5 and the lateral position determined in step S6. The control of the function can be performed, for example, by the processor 81.

The method starts over with executing step S1, i.e. the graphical output is refreshed by displaying a current frame. The new current frame can be influenced by the foregoing touch action. The method can end when no current frame is required any more or input via the touch action is disabled.

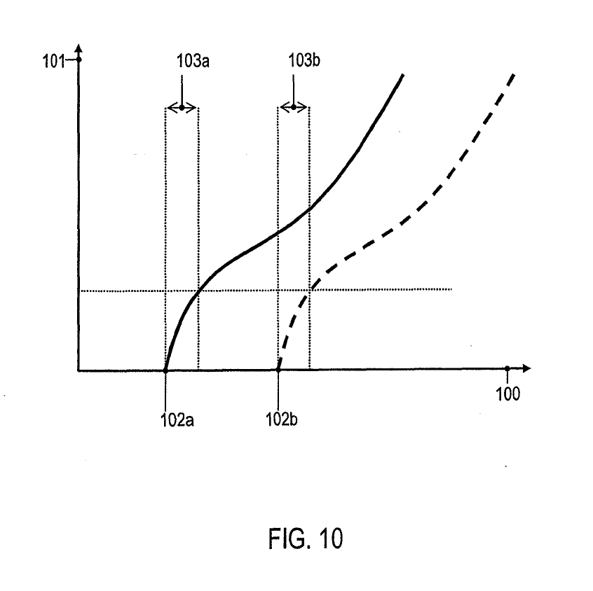

Next, turning to FIG. 10, the dependency of the force 101, in particular a magnitude of the force 101, on the capacity 100 sensed by the sensor system 50 is discussed. Depicted is the dependency of the magnitude of the force 101 on the sensed capacity 100 for two different portable electronic devices (being depicted as full line and dashed line). As can be seen, for example due to manufacturing tolerances, the dependencies of the force 101 on the capacitance 100 are offset by a certain amount with respect to each other. In particular, reference capacitances or baseline capacitances 102a, 102b, for the case where zero force is applied, differ. However, the dependencies of the force 101 on the capacitance 100 qualitatively agree. This allows, by sensing differences of the capacitance to the reference capacitances 102a, 102b, i.e. by sensing offset capacitances 103a, 103b, to accurately determine the magnitude of the force 101. The offset capacitances 103a, 103b in FIG. 10 have almost the same value for a given force 101. Differences in the dependency of the force 101 on the capacitance 100 due to manufacturing tolerances or, for example, due to a varying width of the gap 9 of FIGS. 2 and 3 can be reduced.

Although the invention has been shown and described with respect to certain preferred embodiments, equivalents and modification will occur to others skilled in the art upon the reading and understanding of the specification. The present invention includes all such equivalents and modification and is limited only by the scope of the appended claims.

1. A touch screen responsive to a touch action and arranged in a housing having a bottom surface, wherein the touch screen comprises:
a display for displaying through a front surface of the display, wherein the display is mounted inside the housing and further comprises a back surface being offset by a gap from the bottom surface of the housing in a direction perpendicular to the bottom surface;
a sensor system being interposed between the back surface and the bottom surface, the sensor system comprising:
a first electrode assembly comprising at least one electrode, and
a second electrode assembly comprising at least one electrode, the sensor system being configured to sense a capacitance between the first electrode assembly and the second electrode assembly; and
a processor, the processor being configured to determine, based on the sensed capacitance, a force resulting from the touch action.

2. The touch screen according to claim 1, wherein the at least one electrode of the first electrode assembly is integrally formed by the back surface of the display or is attached to the back surface of the display.

3. The touch screen according to claim 1, wherein the at least one electrode of the second electrode assembly is integrally formed by the bottom surface of the housing or is attached to the bottom surface of the housing.

4. The touch screen according to claim 1, wherein the processor is further configured to determine the force based on a difference of the sensed capacitance to a reference capacitance.

5. The touch screen according to claim 1, wherein the sensor system is further configured to sense the capacitance spatially resolved and the processor is further configured to determine a lateral position of the touch action based on the spatially resolved sensed capacitance.

6. The touch screen according to claim 1, wherein the display is a liquid crystal display having a back-reflector forming the back surface.

7. The touch screen according to claim 1, wherein at least one of the bottom surface of the housing, the back surface of the display, the first electrode assembly, or the second electrode assembly is made from a material selected from the group comprising: conductive material, copper foil, electrolyte copper, metal.

8. The touch screen according to claim 1, further comprising:
a further sensor system arranged offset to the front surface of the display in a direction perpendicular to the front surface, wherein the further sensor system is configured to sense a further signal; and
a further processor being configured to determine, based on the further signal, a lateral position of the touch action with a further lateral spatial resolution.

9. The touch screen according to claim 8, wherein a lateral spatial resolution of the sensor system is smaller than the further lateral spatial resolution of the further sensor system.

10. The touch screen according to claim 1, wherein the sensor system is configured to individually sense the capacitance between the at least one electrode of the first and second electrode assemblies and the processor is further configured to determine the force in a spatially resolved manner based on the individually sensed capacitance.

11. The touch screen according to claim 1, wherein at least one of the first electrode assembly or the second electrode assembly comprises at least four electrodes which are arranged in a lateral pattern.

12. The touch screen according to claim 1, wherein the at least one electrode of at least one of the first electrode assembly and the second electrode assembly has an outer circumference substantially congruent with outer edges of the back surface or the bottom surface, respectively.

13. The touch screen according to claim 1, wherein the first electrode assembly covers an area substantially equal to an area covered by the back surface and/or the second electrode assembly covers an area substantially equal to an area covered by the bottom surface.

14. The touch screen according to claim 1, wherein the display comprises electronic circuitry being positioned offset from the back surface and wherein the at least one electrode comprised in the first electrode assembly is coupled to the electronic circuitry and wherein the sensor system addresses the at least one electrode comprised in the first electrode assembly via the electronic circuitry to sense the capacitance.

15. The touch screen according to claim 1, wherein the first electrode assembly comprises a plurality of top electrodes and the second electrode assembly comprises a single bottom electrode, wherein the bottom electrode is a ground electrode.

16. A portable electronic device, comprising:
a main body comprising a housing having a bottom surface, the housing forming a recess in the main body; and
a touch screen responsive to a touch action and being arranged in the housing, the touch screen comprising:
a display for displaying through a front surface of the display, wherein the display is mounted inside the housing and further comprises a back surface being offset by a gap from the bottom surface of the housing in a direction perpendicular to the bottom surface;
a sensor system being interposed between the back surface and the bottom surface, the sensor system comprising:
a first electrode assembly comprising at least one electrode, and
a second electrode assembly comprising at least one electrode,
the sensor system being configured to sense a capacitance between the first electrode assembly and the second electrode assembly; and
a processor, the processor being configured to determine, based on the sensed capacitance, a force resulting from the touch action, wherein the processor is further configured to control at least one function of the portable electronic device based on the determined force.

17. The portable electronic device according to claim 16, wherein edges of the touch screen are substantially flush with edges of the recess formed by the housing in the main body.

18. The portable electronic device according to claim 16, wherein the at least one electrode of the first electrode assembly is integrally formed by the back surface of the display or is attached to the back surface of the display.

19. A method of operating a touch screen comprising a display and being arranged in a housing, the method comprising:
displaying through a front surface of the display,
sensing a capacitance between a first electrode assembly and a second electrode assembly of a sensor system, the sensor system being interposed between a bottom surface of the housing and a back surface of the display opposing the front surface of the display,
determining, based on the sensing of the capacitance, a force resulting from the touch action.

20. The method according to claim 19, wherein the touch screen is arranged in a housing having a bottom surface, wherein the touch screen comprises:
a display for displaying through a front surface of the display, wherein the display is mounted inside the housing and further comprises a back surface offset by a gap from the bottom surface of the housing in a direction perpendicular to the bottom surface;
a sensor system interposed between the back surface and the bottom surface, the sensor system comprising:
the first electrode assembly comprising at least one electrode, and
the second electrode assembly comprising at least one electrode,
the sensor system being configured to sense a capacitance between the first electrode assembly and the second electrode assembly; and
a processor, the processor configured to determine, based on the sensed capacitance, a force resulting from touch action.
